(19) United States
(12) Patent Application Publication
(10) Pub. No.: US 2011/0168634 A1
(43) Pub. Date: Jul. 14, 2011

(54) PROCEDURE FOR THE PREPARATION OF CONSTANT HEIGHT CALCITE BEDS WITH TURBID WATER CONTROL

(75) Inventor: Manuel Hernandez Suarez, Islas Canarias (ES)

(73) Assignee: FUNDACION CANARIA CENTRO CANARIO DE AGUA, Santa Cruz de Tenerife, Islas Canarias (ES)

(21) Appl. No.: 12/998,131

(22) PCT Filed: Sep. 2, 2009
(86) PCT No.: PCT/ES2009/000435

§ 371 Date: Mar. 21, 2011

(30) Foreign Application Priority Data
Sep. 25, 2008 (ES) P200802728

(51) Int. Cl. B01D 15/00

(52) U.S. Cl. 210/661

(57) ABSTRACT

The present patent refers to a new procedure for the preparation of constant height calcite beds through the continuous dosing of calcite by gravity under water, along with the control of whatever turbid waters might be generated during use of the procedure. The procedure is characterized by the use of a structure of dosing cones that allows for the continuous dosing of calcite by gravity under water and directly onto the surface of the bed. It also incorporates a grid for supporting the dosing cones, a silo with a floor made up of these dosing cones, an inner perimetric spillway below the cone support structure, a filtering floor for the uniform distribution of water or air below the calcite bed and, finally, a turbid water collection and recirculation circuit.

The present patent refers to a new procedure for the preparation of constant height calcite beds based on the continuous dosing of calcite by gravity under water, along with the control of whatever turbid waters might be generated during use of the procedure.

1. Introduction

Granulated calcite beds or filters are used for the remineralisation of soft and corrosive waters, especially in the post-treatment of waters from desalination plants.

As they flow across the beds, waters of this type dissolve the calcite stones, generating calcium bicarbonate until a point of chemical equilibrium known as the saturation point is reached.

Each type of water requires a given contact time inside the calcite bed to reach the desired chemical equilibrium. This contact time may vary from 4 to 30 minutes depending on the type of water and temperature.

2. Technical State of the Art

At present, the calcite beds may be of either the upward or downward flow type, with a granulometry varying between 1 and 5 mm and a height of between 1.5 and 3.5 metres. In both upward and downward flow beds, the consumption of the calcite produces a continuous reduction in the height of the beds. This means the need for periodic recharging and the need to construct the beds with a greater height than is actually required, in order to guarantee that the contact time is in all cases longer than that desired between recharging operations. Depending on the technical limitations, the recharging operations are normally performed every 10-14 days. This implies the addition of between 25 and 40 centimetres of calcite on each occasion, depending on the consumption of the water treated.

The replacement operations are performed by pouring the calcite directly on the upper part of the bed, under dry conditions or wet conditions with a water jet entrainment system.

Calcite beds are always submerged and the elevation of the surface of the water is generally some 80-100 cm above the surface of the bed. The granulated calcite is always accompanied by a fine dust that makes the water turbid and needs to be removed. For this reason, calcite recharging operations must be accompanied by a strong backwashing process. Backwash waters are turbid and are either poured into decanting tanks or, in certain cases, straight into the sewers, since they are not toxic.

In addition and specifically downward flow beds require backwashing every so often in order to avoid obstruction by the fines that are deposited on the bottom of the bed, which may eventually obstruct the drainage floor orifices. In general, these backwashing processes are made to coincide with the filling operations.

Although the upward flow beds do not present any problem as regards obstruction of the bottom, they do cause a serious problem of turbidity during recharging processes.

The consumption of backwashing water and the control of turbid waters are the factors that currently limit the application of calcite beds in processes such as the remineralisation of desalinated waters, where water costs are high and space limited.

3. Origin of the Continuous Dosing Procedure

The state of the art having been analysed, it may be concluded that to date no advantage has been taken of the fact that granulated calcite does not become packed down when under water, rather keeping a loose granular structure similar to sand, other than by the procedure contemplated in this patent.

This behaviour has made it possible to design a bed recharging procedure that operates by gravity, continuously replacing the calcite consumed in the bed.

In the procedure covered by this invention, the calcite descends slowly via dosing cones that cross the flooded area above the beds, replacing the calcite on the surface of the bed, grain by grain and as required, and thus maintaining a bed of constant height.

The surface of the calcite bed acts as a natural stop, controlling the downward movement of the granulated material through the dosing tubes. Only the lowering of the bed will allow for the lowering of the material.

Dosing is thus performed gradually, grain by grain, under the water, avoiding turbidity problems.

4. Origin of the Procedure for the Preparation of Constant Height Calcite Beds

The discovery of the constant dosing procedure described in the previous paragraph has made it possible to develop an entire procedure for the preparation of constant height calcite beds.

The procedure uses a cell or tank housing a calcite bed with a filtering floor in its lower part, and also a series of new elements to guarantee constant dosing, uniform collection of the treated water and control of turbid waters.

The procedure contemplated in this patent uses a plate formed by large dosing cones resting on a grid structure. The dosing cone plate is also the base of a silo in which the calcite is stored. In this way the calcite passes directly from the silo to the surface of the bed via the dosing cone floor, through the sheet of water covering the bed. This guarantees a continuous and uniform dosing process across the entire surface of the bed. This special silo is an integral part of the procedure contemplated by this patent.

In addition, the procedure uses an inner perimetric spillway located below the cone support structure which adapts to the walls of the cell or tank and allows for uniform collection of the water around the entire perimeter.

The assembly comprising the dosing cone plate, support structure, upper silo and filtering floor beneath the bed is an integral part of the procedure constituting this invention.

5. Origin of the Turbid Water Control Procedure

Although, as has been explained in previous paragraphs, the procedure contemplated by this patent avoids the problems of turbidity associated with periodic recharging, it is still necessary to control the turbid waters generated during the initial filling of the filters and during the air-based expansion processes performed once or twice a year in order to prevent the formation of preferential courses or channels in the bed.

With a view to controlling these turbid water flows, the procedure incorporates a collection and recirculation circuit at the beginning of the process and upstream of the remineralisation.

The particles of calcite that cause the waters to become turbid are thus quickly dissolved in the corrosive water upstream of the entry to the beds. This serves to eliminate turbid water discharges.

6. Improvements Provided by the Procedure Contemplated by This Patent

As regards the technical state of the art, the procedure contemplated by this procedure implies the following improvements:

It is a procedure that allows for the creation of constant height calcite beds, this in turn allowing for maintenance of the same contact time in all cases and, consequently, constant performance.

It is a procedure that allows for the creation of constant height calcite beds, this avoiding hydraulic mismatches in all units operating in parallel, regardless of their number.

It is a procedure that allows for gradual and continuous dosing, this avoiding the problems of water turbidity associated with periodic recharging.

It is a procedure that allows for operating periods of up to four times longer than possible to date.

Finally, it is a procedure that allows turbid waters to be collected and recirculated during initial charging and bed expansion processes, thus avoiding the need for discharges.

7. Invention Operating Mode

The procedure contemplated by this patent may be used, with the corresponding adjustments, with both upward and downward flow beds. The operation of the proposed apparatus with an upward flow type bed is described below.

The water enters via the lower part of the tank and is distributed through the filtering floor. It then flows upwards through the bed. As it passes through the bed, the chemical composition of the water is corrected and its condition improved. The time taken by the water to flow through the bed depends in each case on the design conditions of each project.

Having flowed through the bed, the water enters a backwater area of approximately 80 cm and flows over an inner perimetric spillway. This spillway collects the water and channels it to a lateral outlet.

Above the perimetric spillway there is a grid-shaped support structure that holds the dosing cone plate.

The dosing cones constitute the floor of a calcite storage silo located over the bed and forming an integral part of the tank. The recharging of the calcite is accomplished directly in the silo, thus feeding the dosing cones.

The dosing cones cross the backwater area and dose the calcite directly onto the surface of the bed, under water.

With this procedure the dosing is accomplished very gradually via the dosing cones, without creating any turbulence. The system is fed automatically by gravity as the calcite bed is consumed.

The calcite silo allows for autonomous operation of the procedure over periods of several weeks. The product in this in-built silo remains dry, while the dosing zone is below the water.

The calcite is moistened only in the cone downcomer tubes; however, as the granulated material is inert, i.e., it neither absorbs water nor is easily dissolved, there are no problems of obstruction.

In the upward flow bed type described in this section, the water needs to have sufficient pressure to overcome the loss of charging head implied by the filtering floor, the calcite bed and the backwater zone. In the bed described, the treated water exits the system at atmospheric pressure.

8. Main Elements of the Procedure Contemplated by the Patent

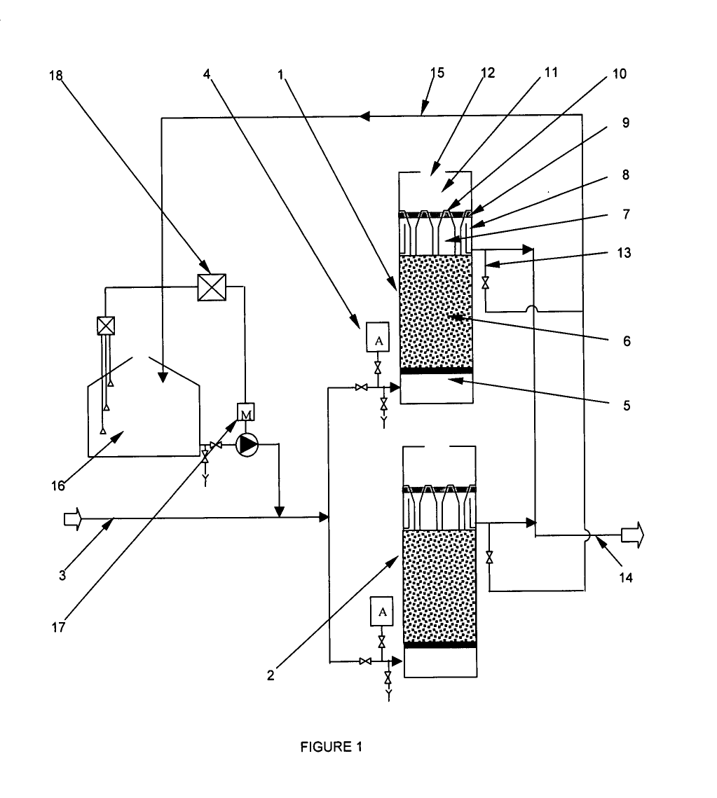

The main elements that make up the procedure covered by this patent are set out in FIG. 1, attached hereto. This figure shows the elements of an installation with two identical tanks (1) and (2) positioned in parallel. These tanks house upward flow constant height calcite beds and each has an independent recirculation circuit. The figure reflects a preferential configuration by way of an example and is not limiting.

The elements shown in FIG. 1 are as follows: (1) Tank with upward flow constant height calcite bed; (2) Tank with upward flow constant height calcite bed identical to that in (1); (3) Entry of untreated water; (4) Pressurised air injection point for bed expansion process; (5) Area of the filtering floor for the uniform distribution of air and water below the calcite beds; (6) Granulated calcite bed; (7) Backwater area, (8) Inner perimetric spillway; (9) Dosing cone support structure; (10) Dosing cone plate; (11) Calcite silo for dosing cone feed; (12) Calcite silo charging opening; (13) Deviation for turbid water recirculation circuit; (14) Treated water outlet; (15) Turbid water recirculation piping; (16) Tank for turbid water with level control; (17) Turbid water injection pump; (18) Control panel.

Described below is the operation of the procedure covered by this invention in accordance with the configuration shown in FIG. 1. The water enters by a tube (3) that is divided into two branches: one running to tank (1) and the other to tank (2). These two tanks are identical and will operate in parallel. The pressurised air injection point (4) is located upstream of the entry to each of these tanks. This injection is used at specific moments for the expansion or cleaning of the calcite bed located inside the corresponding tank. The water enters the lower part of the tank and is uniformly distributed via the filtering floor (5), which is especially designed to facilitate the uniform distribution of water or air. It then flows up through the granulated calcite bed (6), crosses the backwater area (7) and flows over the perimetric spillway (8). The dosing cone support structure (9) is anchored to the walls of the tank a short distance above the spillway and supports the plate formed by the dosing cones (10). Above the dosing cones is located the calcite silo that provides feed for these cones (11), which has a charging opening in its upper part (12). Once it has flowed through the bed, the water spills over the perimetric spillway and leaves the system by the pipe (14). In the event of a need to control turbid waters, the deviation to the tank outlet via the pipe (13) channelling the water via the turbid water recirculation line (15) to the turbid water tank (16) is activated. From this tank (16) the turbid water is injected by the pump (17) to the general inlet line (3) to the remineralisation process. The turbid water tank (16) level measuring devices and the recirculation pump (17) are connected to a control panel (18).

Within the essential characteristics of the invention is the detailed variation, also protected, allowing the size and shape of the dosing cones to be varied, along with the dosing cone support plate, the size of the perimetric spillways or the configuration of the recirculation system of filtering floor beneath the bed.

1. Procedure for the preparation of constant height calcite beds with control of turbid waters for soft and desalinated water post-treatment plants made up of several independent upward flow calcite beds, operating in parallel and equipped with a dosing system to maintain a constant bed height, and where all the beds have exactly the same hydraulic countered-pressure at their inlet.

2. Procedure for the preparation of constant height calcite beds with control of turbid waters in accordance with claim 1, wherein the system for the distribution of water at the inlet to the beds feeds all of them with the same flow.

3. Procedure for the preparation of constant height calcite beds with control of turbid waters in accordance with claim 1, wherein all the beds have the same height and the same loss of hydraulic head.

4. Procedure for the preparation of constant height calcite beds with control of turbid waters in accordance with claim 1, wherein all the beds making up the post-treatment plant have the same calcite consumption, regardless of variations in the quality of the post-treatment plant inlet water.

5. Procedure for the preparation of constant height calcite beds with control of turbid waters in accordance with claim 1, wherein the procedure for sponging of the beds making up the post-treatment plant is accomplished individually, bed by bed, by injecting pressurized air into the inlet water of each bed.

6. Procedure for the preparation of constant height calcite beds with control of turbid waters in accordance with claim 1, wherein the turbid waters generated during the bed sponging process are detoured by opening a valve located at the outlet of the bed and prior to mixing with the rest of the treated waters, and channeled to a turbid water tank from where they are injected by means of a pump into the general post-treatment plant inlet duct.
